(19) United States
(12) Patent Application Publication
(10) Pub. No.: US 2003/0095722 A1
(43) Pub. Date: May 22, 2003

(54) Method and apparatus to detect and compensate for skew in a printing device

(76) Inventor: Laurent A. Regimbal, Round Rock, TX (US)

Correspondence Address: HEWLETT-PACKARD COMPANY, Intellectual Property Administration, P.O. Box 272400, Fort Collins, CO, 80527-2400, US

(21) Appl. No.: 09/988,905

(22) Filed: Nov. 19, 2001

(51) Int. Cl. H04N 1/409; G06T 3/60; G06K 15/02

(52) U.S. Cl. 382/296; 358/1.12; 358/1.18; 358/3.26

(57) ABSTRACT

During the printing process, print skew can result from skewed delivery of paper or other sheet media to the print engine or print cartridge. Skew can include a left-right translation component and a rotational component. For example, the leading left comer may be translated to the right and the document rotated counterclockwise about that comer. To solve this problem, a sensor array identifies the left-right translation of a leading comer of the print media, and determines a degree of rotation of the print media about that comer by measuring the leading edge. Using this information, an algorithm maps the print information to compensate for the skew. The mapped print information results in resampled print information, as indicated by the print media's translation and rotation. Accordingly, the print engine prints text and other print images that are not skewed with respect to the print media.

### TECHNICAL FIELD

This invention relates to a software solution to the problem of misaligned paper in a printer. More particularly, this invention relates to sensing the left-right translation and angular rotation of the print media, and to translating the output location of pixels, so that the print image is aligned with the print media.

### BACKGROUND

In many printers, it common for an occasional page, envelope or other sheet media to have print output that is somewhat skewed. Print output can be skewed due to rotation; e.g. the print media can be rotated with respect to the print output. Alternatively, the printed output may be translated too much to the left or right. Typically, skew includes both rotation and translation.

Skewed printer output generally results from a failure of the electromechanical paper handling mechanism. The failure results in the print media moving through the paper path with a skewed orientation. The resulting print output is therefore skewed with respect to an intended orientation on the paper or other sheet media.

Unfortunately, even a minor skew is frequently noticeable, since lines of text and graphical elements that are presumed to be vertical or horizontal are easily compared to the edge of the paper and seen to be skewed. Similarly, skew commonly results in a variation in the width of the margin defined outside the printed region of the media, immediately suggesting a printer skew.

In an attempt to correct different failure modes seen in paper handling assemblies, a variety of electromechanical advancements have been made. However, electromechanical solutions to the skew problem typically result in more complex paper alignment and delivery assemblies. Unfortunately, such complexity adds to the cost to the printer and may result in a decrease in the mean time between failures.

Accordingly, there is a need for an improved solution to the problem of printer skew that solves the problem with greater reliability, higher accuracy and lower cost.

### SUMMARY

Systems and methods for detecting and correcting print skew are disclosed. If the paper fed by a paper handling mechanism of a printer is skewed, a mapping algorithm is used to rotate and translate the print output to compensate for the skew. Accordingly, while the print media may move through a paper path within the printer with either a rotated and/or translated orientation, the print output is also rotated and/or translated to the same degree, causing the print image and the print media to be correctly aligned.

### BRIEF DESCRIPTION OF THE DRAWINGS

The same numbers are used throughout the drawings to reference like features and components.

FIG. 1 is an illustration of a printer and a printer server.

FIG. 2 is an illustration of a sensor array within a printer, particularly showing the relationship of the sensor array to an electromechanical paper handling mechanism, and showing a sheet of paper moving along the paper path within the printer.

FIG. 3 is an illustration similar to FIG. 2, but showing a skewed sheet of paper moving through the print path.

FIG. 4 is a block diagram illustrating the relationship between exemplary software structures associated with the method and apparatus to detect and compensate for skew in a printing device.

FIG. 5 is a flow diagram illustrating a method of using the apparatus to detect and compensate for skew in a printing device.

FIG. 6 is a diagram illustrating additional detail associated with the operation of a first print data buffer, a mapping module and a second print data buffer.

### DETAILED DESCRIPTION

During the printing process, print skew can result from skewed delivery of paper or other sheet media to a laser or inkjet print engine. Skew can include a left-right translation component and/or a rotational component. For example, the leading left comer may be translated to the right and the document rotated counterclockwise about that comer. To solve this problem, a sensor array identifies the left-right translation of a leading comer of the print media, and accurately determines a degree of rotation of the print media about that comer by measuring the leading edge. Using this information, an algorithm maps the print information to compensate for the skew. The mapped print information reflects a relocation of each pixel, as indicated by the print media's translation and rotation, resulting in skew-corrected print information. The skew-corrected print information results in print output that is not skewed with respect to the print media.

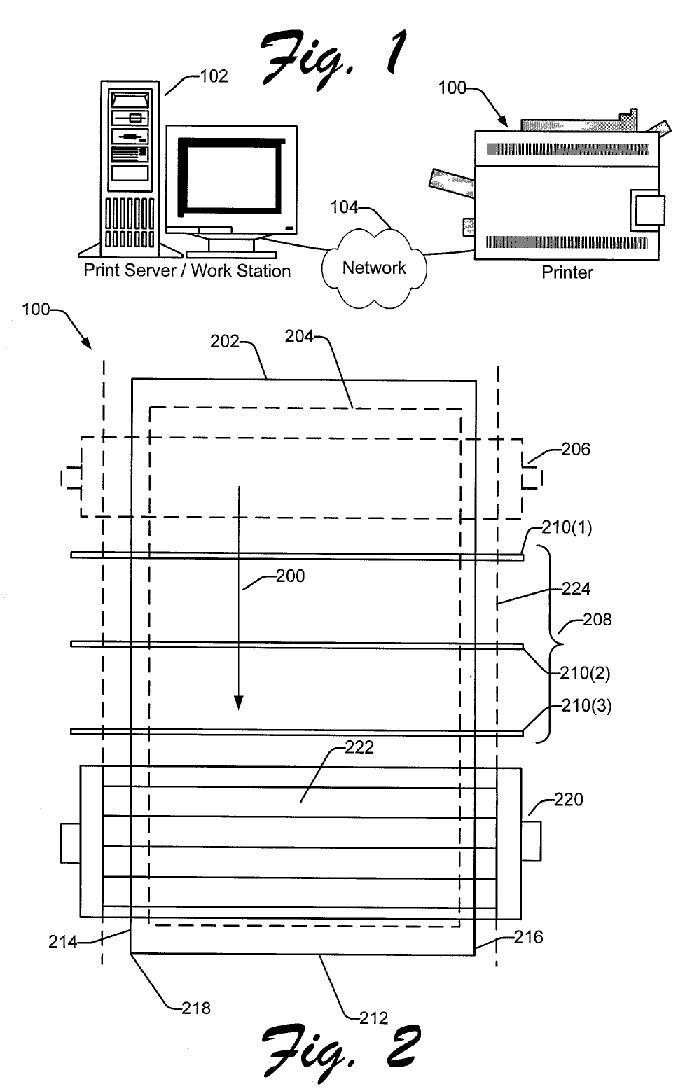

FIG. 1 shows a printer 100 or similar output device such as a facsimile machine, copy machine, and multi-function output device connected to a print server 102, workstation or similar computing device. The printer or other output device may be based on a print engine having laser/toner technology, an ink-jet cartridge or other technology. The printer may be adapted for use with print media including paper, envelopes, mailing labels or other documents. The connection between print server and printer may be made by network 104, cable or over the Internet, as required to support any desired application.

Although the apparatus and method of detection and compensation for skew in a printing device is described in a context wherein most of the computational steps are performed on a printing device, many of the tasks could alternatively be performed on the print server or other computing device in communication with the printing device. Where the computational steps are performed on the printing device, the printing device may be equipped with computer- and/or microprocessor-readable media having computer- and/or microprocessor-readable instructions. Alternatively, a computationally equivalent hardware-based solution may be substituted, using an application specific integrated circuit (ASIC) or similar technology. Execution of such software-, firmware- or hardware-based instructions supports skew detection and compensation, as shown and described.

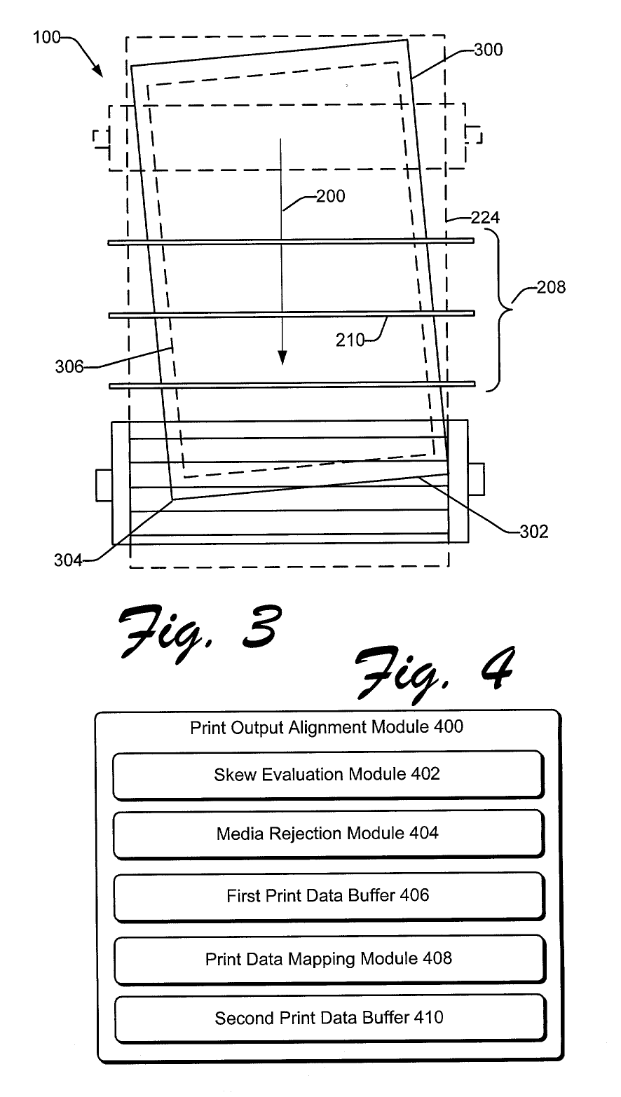

FIG. 2 shows a view within the printer 100, particularly showing a paper path 200 traveled by sheet media 202 during the printing process. The sheet media, typically a piece of paper, envelope, mailing label or other material, include a printed area within a margin 204. An electromechanical paper handling and registration assembly 206 guides the sheet media through the paper path. In the view of FIG. 2, the paper is properly aligned with respect to the registration assembly, indicating the success of the paper handling assembly in maintaining the paper in the desired orientation.

A media location sensor array 208 includes at least one sensor 210. The sensor array is able to detect the leading edge 212, and at least one of left edge 214 or right edge 216 of the paper or other sheet media. In particular, the sensor array is able to detect with necessary precision the location of the leading left (or right) comer 218, and a measurement of any left-right translation. The sensor array is also able to accurately measure the angle by which the leading edge 212 varies from its desired orientation. In general, the preferred orientation of the leading edge is perpendicular to the paper path 200. In one implementation of the sensor array, optical sensors are able to detect sub-millimeter translation of the leading left corner, and fractional degrees of rotation of the leading edge.

A print engine 220 transfers print output to the print media. In one implementation, a laser print engine is used. Alternatively, ink jet or other technologies could be substituted. The print engine includes a drum, on which length-wise toner deposits 222 are associated with rows of pixels. Revolution of the drum results in deposition of toner on the print media in accordance with the horizontal lines of pixels. The width of the print engine in general, and the length of the horizontal lines of pixels in particular, determine the width the engine's printable region 224.

FIG. 3 shows a view within the printer 100 that is similar to that of FIG. 2. However, in the view of FIG. 3, skewed sheet media 300 is traveling through the paper path 200. A sensor 210 within the sensor array 208 detects a skewed leading edge 302 of the skewed sheet media, and accurately measures the angle by which it is rotated from its desired orientation. Similarly, the sensor array detects the leading left (or right) corner 304 and measures the left-right translation of that corner with respect to its desired location. The rotation of the leading edge 302 and the translation of the leading left corner 304 constitute a skew by which the skewed sheet media is displaced from the desired location. The skew illustrated in FIG. 3 is not sufficient to result in any portion of the sheet media within the margins 306 from extending outside of the engine's printable region 224.

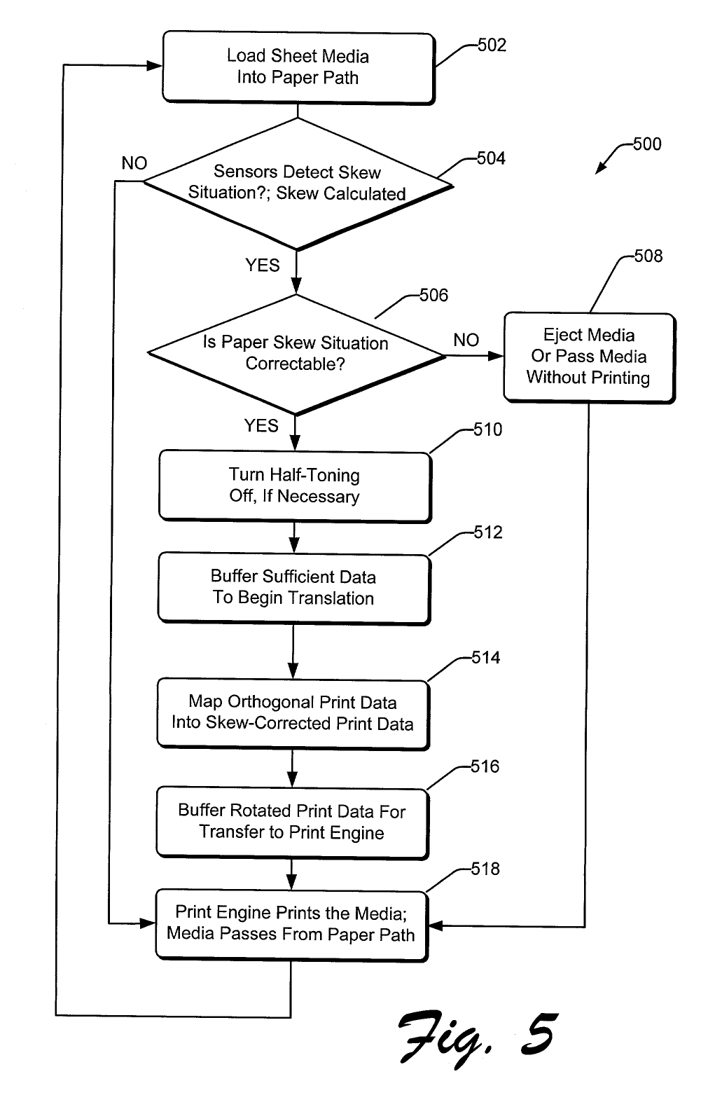

FIG. 4 shows a block diagram illustrating an implementation of a print output alignment module 400. The print output alignment module may be implemented as a software structure including statements executed by a processor, or may be implemented in hardware, such as by an application specific integrated circuit (ASIC).

The print alignment module 400 determines if the print media is sufficiently skewed from its intended orientation to require correction. Where sufficient skew exists, the degree of skew is measured. Two measurements are typically made: the left-right translation of a leading comer and the angle of rotation of the leading edge. Print information received from a print server is buffered. The print information is associated with an initial location for each pixel, suitable for use with non-skewed print media. When sufficient media skew is present, the print information is mapped to skew-corrected print information. The skew corrected print information is determined in a mapping process by re-sampling the un-skewed print information at new pixel locations, thereby recalculating each pixel value (in each color for multicolor images) at a new pixel location, as needed given the skew of the print media moving through the paper path of the printer. This may be done by using any of a number of well-known interpolation or re-sampling algorithms. Thus, by re-mapping the image information depending upon the skew of the print media, the effect of the skew of the print media is fully negated, and the print output is indistinguishable from print output associated with non-skewed print media.

A skew evaluation module 402 interprets signals sent by the sensor array and determines the skew of the print media. In response to print media traveling within the paper path, one or more sensors 210 within the sensor array 208 transmits information to the skew evaluation module. In one implementation, the information includes an accurate measurement of the left-right translation of the leading left (or right) comer of the print media from the desired location of that comer. The sensors also measure the angle of the leading (or other) edge, to accurately determine the angle by which the print media is rotated from the desired orientation.

A media rejection module 404 receives information from the skew evaluation module 402 on the rotational and translational components of the skew of the sheet media moving through the paper path. The media rejection module determines, given certain constraints, if the sheet media should be ejected from the paper path without printing. The constraints considered by the media rejection module include the likelihood of media damage due to paper jam or other interference involving the media. Generally, the media rejection module should allow the media to pass through the paper path, unprinted, if the skew exceeds a threshold value. The skew would be considered too great, for example, if damage to the media would result, or if portions of the media within the margins 204 pass outside the print region 226.

A first print data buffer 406 receives print information from the print server, workstation or other device. The print information may be considered to be “unskewed” print information, i.e. information appropriate for use when the media is unskewed.

A mapping module 408 inputs unskewed print information from the first print data buffer 406. The mapping module creates skew-corrected print information, which is sent to the second buffer 410. In the mapping process, location information associated with the location of each pixel contained within the unskewed print information is mapped by an amount required to compensate for the skew of the print media moving through the paper path. This adjusted location information is included within the skew-corrected print information. Therefore, the mapping module maps print information associated with the location of each pixel a distance indicated by the combined effect of the left-right translation and the angular rotation of the print media. This results in skew-corrected print information. The skew-corrected print information, when acted upon by the print engine, ink-jet or other output device, results in the same print output on skewed print media as would result from unskewed print information on non-skewed print media.

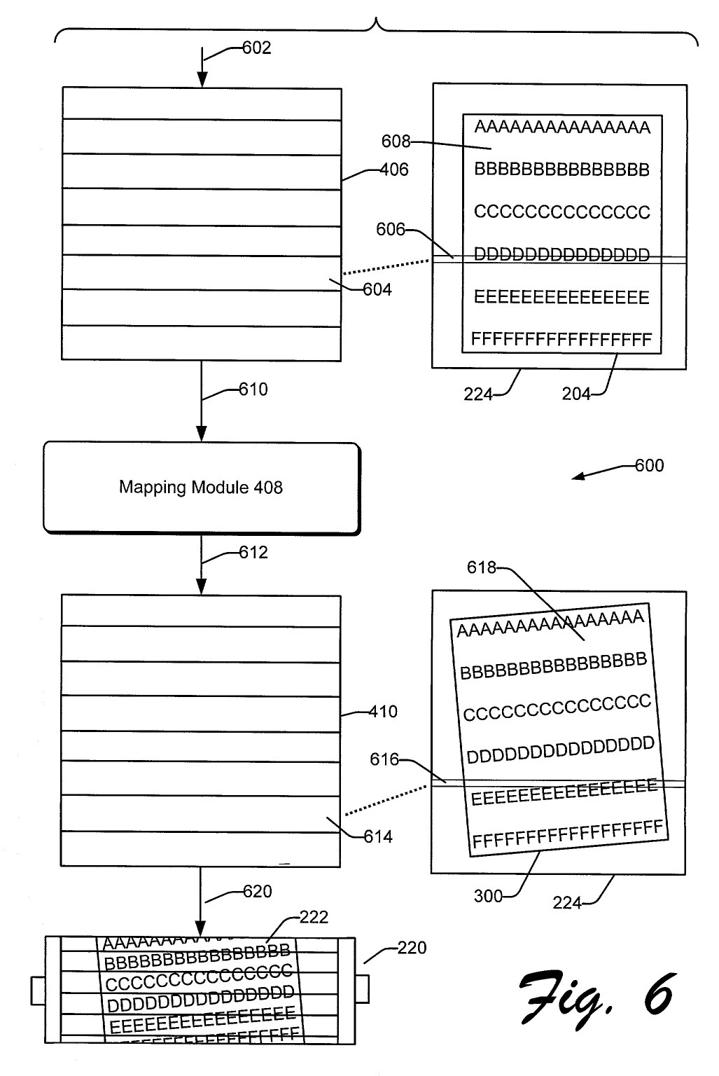

Translation and rotation algorithms are both known, and will therefore not be discussed in detail herein. Appropriate algorithms are combined to form a mapping function that can input unskewed print data and output skew-corrected print data. The unskewed print data is associated with print output that is required in the event seen in FIG. 2, wherein the print media 202 and print region 224 are not skewed. The skew-corrected print data is associated with print output that is required in the event seen in FIG. 3, wherein the print media 300 and the print region 224 are skewed. A further discussion of the operation of the rotation module 408 is seen in the discussion of FIG. 6.

A second print data buffer 410 receives the output of the mapping module 408. The output, in the form of mapped print information, is buffered for transmission to the print engine.

FIG. 5 shows a method 500 by which the degree of the skew between the actual print media location and the desired print media location is detected and measured. The method is additionally adapted to map the unskewed print data into skew-corrected print data. The skew-corrected print data is then transmitted to a print engine or other output device to create a pixel pattern forming a print image that is correctly oriented with respect to the print media.

At block 502, the paper handling and registration assembly 206 loads a sheet of paper, envelope, mailing label or other sheet media into the paper path.

At block 504, the skew evaluation module 402 takes a measurement of the print media skew. A determination is made if a skewed-media situation exists by evaluating the measurement of the print media skew associated with the print media moving through the paper path of the printer. In the course of the evaluation, the skew evaluation module 402 communicates with one or more sensors 210 within the sensor array 208. In one implementation, the location of the leading left (or right) corner is accurately determined. The left-right translation of that corner from the intended location is then calculated. Similarly, the angle of the leading edge of the print media is determined and the angular rotation from its intended orientation is calculated. This information is then reported to other modules, including the media rejection module 404 and the mapping module 408.

At block 506, the media rejection module 404 makes a decision to print or not print, based on the degree of skew determined by the skew evaluation module 402. Where the degree of skew is excessive, the media may be passed through the printer without printing. Excessive skew would include those circumstances where print media within the margins 204 extends beyond the print region 224 or where the left or right edges of the print media may be damaged by the printer.

At block 508, if the media rejection module determines that it is necessary, the media is ejected without printing, or a jam is declared and the appropriate error handler is called.

At block 510, if a halftoning routine exists that is incompatible with the operation of the mapping module 408, then operation of the halftoning routine is turned off. Where rotation of the existing halftoned image is possible, this is done. Where this is not possible, the image can be rotated and then halftoned again.

At block 512, the first print data buffer 406 fills with sufficient unskewed print information to allow the mapping module 408 to operate. This is particularly true when the output of the print data-mapping module is organized as horizontal rows of pixels.

At block 514, the mapping module 408 creates skew-corrected print data by mapping unskewed print data into skew-corrected print data. In one implementation, the mapping module inputs print data from the first print data buffer 406 containing unskewed print information. Typically, print data associated with several horizontal lines of pixels are input to the mapping module, to allow for sufficient data to be present to allow data segments of skew-corrected print data associated with a horizontal line of skew-corrected pixels to be output. Due to the rotational component of the skew of the print media, one horizontal row of skew-corrected data may contain some information originally found in the print information associated with several rows of un-skewed print information.

The skew-corrected print data is output in any desired format. For example, the skew-corrected print data may be output pixel by pixel. Alternatively, the skew-corrected print data may be output in data segments associated with a horizontal line of pixels. Such data segments may be more conveniently utilized to drive the print engine.

At block 516, the second print data buffer 410 is loaded with the skew-corrected print data output by the rotation module 408. As needed, skew-corrected print data is removed from the buffer 410 and sent to the print engine 220.

At block 518, the print engine completes the printing process, and the media is ejected from the paper path 200.

FIG. 6 shows an exemplary implementation 600 of the operation of the first print data buffer 406 containing unskewed print data, the mapping module 408 and the second print data buffer 410 containing skew-corrected print data. The first print data buffer 406 may be implemented with a first-in/first-out (FIFO) structure, which receives print data at 602 from a print server, workstation or other device. The data may be arrayed as data segments 604, each associated with a horizontal row of pixels 606 in the print process. The data in the buffer 406 is therefore associated with print output 608 defined within the margins 204 of print media entirely within a print region 224. Because the print information is associated with print output that is unskewed with respect to the print region and margins, the print output will appear skewed if the print media is skewed.

As required, print data is moved at 610 to the mapping module 408. The print information is mapped as indicated by the skew information from the skew evaluation module. Accordingly, print information associated with the location of each pixel is modified by the appropriate left-right translation and angular rotation.

The output of the mapping module is moved at 612 into the second print data buffer 410, containing skew-corrected print information. The skew-corrected print data buffer may be organized as a FIFO device, having a plurality of data segments 614, each associated with horizontal rows of pixels 616. The data within the rotated print data buffer 410 is therefore associated with print output 618 defined within the margins of a skewed print media 300 within a print region 224.

Each data segment 614 is output from the second print buffer 410 having skew-corrected print information at 620 and sent to the print engine 220. Each data segment may be associated with one horizontal line of pixels 222, carried by the print engine. Because of the skew-correction, the print output and the print media are unskewed, despite the skew of the print media with respect to the print engine and paper path through the printer.

In conclusion, by accurately measuring the degree of translation and the angle of rotation of print media, sufficient information may be obtained to facilitate mapping of the location information associated with each pixel of print information, thereby creating skew-corrected print information. By using the skew-corrected print information, the print output may be applied to the print media at an orientation that is adjusted both for translation and rotation. As a result, the print media and print output are properly aligned, and the print media does not have the appearance of having traveled through the paper path of a printer with a skewed orientation.

Although the disclosure has been described in language specific to structural features and/or methodological steps, it is to be understood that the appended claims are not limited to the specific features or steps described. Rather, the specific features and steps are exemplary forms of implementing this disclosure. For example, while one corner and the leading edge have been disclosed as locations for use in determining the location of sheet media, other corners and edges could similarly determine the location of the media.

1. A method, comprising:
measuring a print media skew of print media;
mapping unskewed print information to compensate for the print media skew, thereby creating skew-corrected print information; and
using the skew-corrected print information to apply a print image to the print media.

2. The method of claim 1, wherein measuring comprises:
measuring a left-right translation in a scan direction of the print media; and
measuring an angular rotation of the print media.

3. The method of claim 2, wherein mapping comprises mapping location information associated with each pixel contained within the unskewed print information by an amount required to compensate for the left-right translation and the angular rotation of the print media.

4. A method of claim 1, wherein mapping comprises mapping location information associated with each pixel contained within the unskewed print information by an amount required to compensate for the skew of the print media.

5. The method of claim 1, additionally comprising turning off half-toning to simplify the mapping.

6. The method of claim 1, additionally comprising buffering unskewed print information to provide sufficient input for the mapping.

7. A method, comprising:
taking a measurement of print media skew;
creating skew-corrected print information using the measurement of print media skew; and
applying a print image to print media using the skew-corrected print information.

8. The method of claim 7, wherein taking a measurement comprises:
determining a left-right translation of the print media from a desired location; and
determining an angle of rotation of the print media from a desired orientation.

9. The method of claim 7, wherein creating skew-corrected print information comprises mapping a location of a pixel of unskewed print data according to the print media skew.

10. The method of claim 7, additionally comprising turning off halftoning to simplify creating skew-corrected print information.

11. A system, comprising:
a sensor to sense skew of print media within a printer; and
a print output alignment module to align print output according to the skew of the print media.

12. The system of claim 11, wherein the print output alignment module comprises:
a skew evaluation module to interpret measurements made by the sensor; and
a print data mapping module to map unskewed print data to skew-corrected print data.

13. The system of claim 11, additionally comprising a first print data buffer to store unskewed print data.

14. The system of claim 1, additionally comprising a second buffer to store skew-corrected print data.

15. The system of claim 11, additionally comprising a media rejection module to reject the print media if the skew exceeds a threshold value.

16. A system to detect and compensate for print media skew within a printer, comprising:
a skew evaluation module to interpret measurements made by a sensor and determine print media skew;
a media rejection module to reject print media if the print media skew exceeds a threshold value;
a first print data buffer to store unskewed print data;
a print data mapping module to map the unskewed print data to skew-corrected print data; and
a second buffer to store the skew-corrected print data.

17. A computer-readable medium having processor-executable instructions thereon which, when executed by a processor, cause the processor to:
measure skew of print media;
create skew-corrected print information according to the skew; and
apply a print image to the print media according to the skew-corrected print information.
